(19) United States
(12) Patent Application Publication
(10) Pub. No.: US 2006/0256882 A1
(43) Pub. Date: Nov. 16, 2006

(54) Method and apparatus for adjusting transmission parameters to improve a communication link

(75) Inventors: Steven Jeffrey Goldberg, Downingtown, PA (US); Fatih Ozluturk, Port Washington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/173,025

(22) Filed: Jul. 1, 2005

Related U.S. Application Data
(60) Provisional application No. 60/680,882, filed on May 13, 2005.

(51) Int. Cl. H04K 1/10; H04B 1/00

(52) U.S. Cl. 375/260; 375/148

(57) ABSTRACT

A method and apparatus is disclosed for minimizing multipath interference in wireless communication systems. A system comprises at least one transmitter and at least one receiver. In the transmitter, transmission beam parameters are dynamically modified using pseudo-random dithering or a sweeping function. The receiver receives an information signal regarding beam parameters or monitors the beam parameters and adjusts its receiving parameters accordingly to optimize its communication link. In an alternate embodiment, the receiver generates and sends feed back information to the transmitter wherein the feed back information may be used to modify beam parameters or perform other functions.

### CROSS REFERENCE TO RELATED APPLICATIONS

This application claims the benefit of U.S. Provisional Application No. 60/680,882 filed May 13, 2005, which is incorporated by reference as if fully set forth.

### FIELD OF INVENTION

The present invention relates to layered space facilitation via beam dithering. More particularly, the present invention relates to a method and apparatus for dynamically modifying transmission beams as a means of improving the robustness of communication links.

### BACKGROUND

The term “multipath” in radio frequency (RF) communications refers to the existence of multiple paths of RF propagation between a transmitter and a receiver. RF signals arriving at a particular receiver via these multiple paths typically comprise a combination of direct and indirect (i.e., reflected) signals. In typical single-input single-output (SISO) systems, wherein RF signals are transmitted from single-antenna transmitters, these direct and reflected signals are often opposite in phase and as a result, often cancel each other out causing signal loss at receiving single-antenna receivers.

In other types of systems, rather than canceling each other out, multiple paths are utilized to transmit independent data streams. In “layered space” or more generally, multiple-input multiple-output (MIMO) systems, multiple antennas are employed in transmitters and in receivers to divide a communication link or channel between a given transmitter and receiver into multiple, spatially separated sub-channels. This spatial division or “spatial multiplexing” enables a MIMO transmitter to transmit independent data streams via these sub-channels on multiple paths to a MIMO receiver. As a result, the system's throughput is increased without increasing the frequency bandwidth.

As with SISO systems, however, MIMO systems also encounter multipath problems. One such problem includes not having enough natural or sufficiently stable transmission paths on which to transmit independent data streams. A lack of transmission paths can prevent MIMO systems from fully maximizing their throughput potential.

Compounding the multipath problems of both SISO and MIMO systems are the unpredictable changes that occur in mobile RF environments. In environments wherein transmitters and/or receivers are mobile, signal paths between a given transmitter and receiver rapidly change. This rapid change can result in carrier cancellation and inter-symbol interference, even in MIMO systems.

A conventional approach for both reducing multipath interference in SISO systems, and for providing a sufficient number of viable paths in MIMO systems, is illustrated in FIG. 1. As shown in FIG. 1, a transmitter 102 adjusts the paths 103 of a transmission beam in the elevation plane until a suitable path to the receiver 104 is identified. Similarly, as shown in FIG. 2, a transmitter 202 may adjust transmission paths 203a, 203b in the elevation 200 and azimuth 250 planes. Adjusting the beam paths 203a, 203b in both the elevation and azimuth 250 planes increases the chances of generating suitable transmission paths.

Feedback signals from a receiver 104, 204 are used to indicate to a transmitter 102, 202 the quality of received signals. Upon receiving an acceptable signal indication, the transmitter 102, 202 ceases making beam adjustments and begins transmitting data signals. If the channel and/or system conditions change, the receiver 104, 204 sends an appropriate indication to the transmitter 102,202, at which point the transmitter 102, 202 begins re-adjusting the transmission beams in search of suitable paths. Since typical channel and/or system conditions change rapidly, as in a communication system with mobile transmitters and/or mobile receivers, it is often difficult for a transmitter 102, 202 to process the feed back information and adjust its transmission beams in a timely manner. Thus, the static generation of paths as illustrated in FIGS. 1 and 2 is effective only in environments that remain static or quasi-static.

Accordingly, it is desirable to have a method and apparatus for generating beam paths that minimize multipath interference in a wireless communication system and maximize the system's data rate in environments when channel and/or system conditions may change.

### SUMMARY

The present invention is a method and apparatus for minimizing multipath interference in wireless communication systems. A system comprises at least one transmitter and at least one receiver. In the transmitter, transmission beam parameters are dynamically modified using pseudo-random dithering or a sweeping function. The receiver receives an information signal regarding beam parameters or monitors the beam parameters and adjusts its receiving parameters accordingly to optimize its communication link. In an alternate embodiment, the receiver generates and sends feed back information to the transmitter wherein the feed back information may be used to modify beam parameters or perform other functions.

### BRIEF DESCRIPTION OF THE DRAWINGS

FIG. 1 illustrates conventional multipath generation in an elevation plane;

FIG. 2 illustrates conventional utilization of elevation and azimuth planes to generate distinct radio frequency (RF) paths;

FIG. 3 illustrates beam dithering in elevation and azimuths planes;

FIG. 4 illustrates a wireless communication system wherein beam dithering is utilized to improve a communication link between a transmitter and a receiver; and

FIG. 5 is a flow diagram for beam dithering in a wireless communication system.

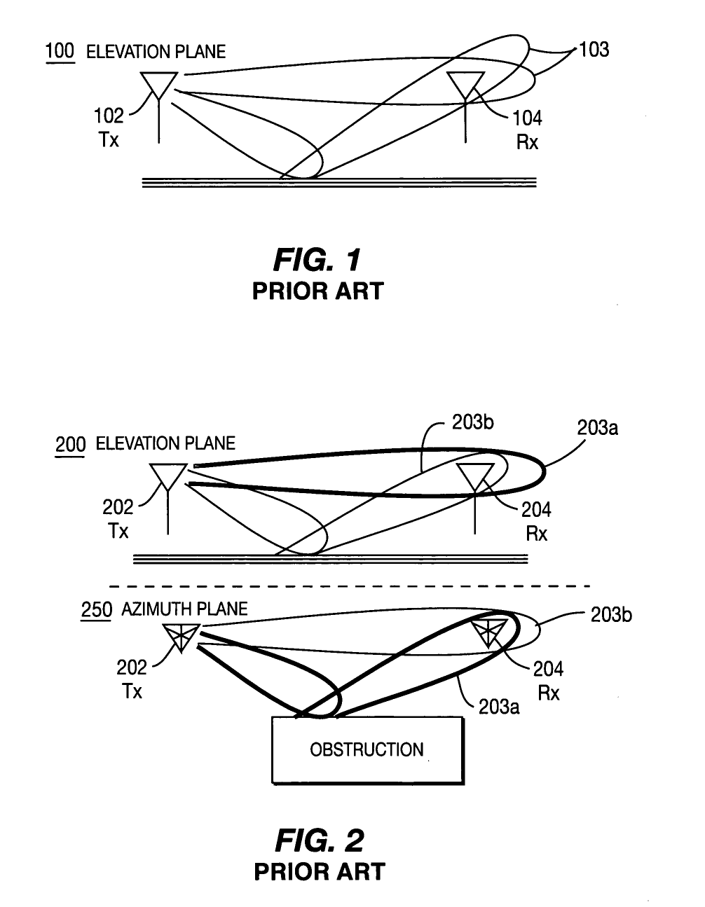

### DETAILED DESCRIPTION OF THE PREFERRED EMBODIMENTS

Herein, a wireless transmit/receive unit (WTRU) includes but is not limited to a user equipment, mobile station, fixed or mobile subscriber unit, pager, or any other type of device capable of operating in a wireless environment. When referred to herein, a base station includes but is not limited to a Node-B, site controller, access point or any other type of interfacing device in a wireless environment.

The term “dithering” is typically associated with the art of imaging and is often used to describe a process of creating the illusion of new colors by modifying or varying patterns of dots in an image. As applied herein, the phrase “dithering” or “beam dithering” is used to describe the modification of one or more beam parameters for the purpose of improving a communication link between a transmitter and a receiver. It should be understood that “beam dithering” is not intended to be a limiting phrase. To the contrary, beam dithering may describe the modification of any beam parameter including beam patterns, beam width power, boresight power, boresight direction, transmission rate, etc., or any combination thereof. The modification of these parameters may also occur in azimuth, elevation, or any combination of the two as practically allowed by the particular equipment in use.

In a preferred embodiment, a transmitter pseudo-randomly dithers transmission beam parameters. The beams may be dithered by modifying their transmission paths in angular elevation, azimuth or both. Additionally or alternatively, other beam parameters such as for example, beam width power and boresight power, may be dithered in a pseudo-random manner. A receiver monitors and tracks the changing beam parameters, processes the changes, and adjusts its receiving parameters accordingly to compensate for the pseudo-random changes if necessary. If the dithering occurs within a sufficiently small range, the need for the receiver to perform such tracking may not exist, or exist only to a limited degree. By pseudo-randomly dithering various beam parameters, long periods of signal interruption and periods of low data rates are effectively curtailed. Even if particular dithering combinations result in, for example, sub-optimal data rates, the pseudo-random nature of the present embodiment ensures that this sub-optimal state is temporary.

To further improve the effects of pseudo-random dithering, upon receiving and processing dithered signals, the receiver optionally generates and transmits feed back signals to the transmitter. These feed back signals may include basic information, such as quality of service (QoS) measurements of received signals, which the transmitter monitors and uses to determine subsequent dithering combinations. In more advanced receivers, the feed back signals may include instructional information that instructs the transmitter as to which parameters to dither and to what extent.

Optionally, the transmitter may utilize the feed back information to optimize the allocation of RF resources presently reserved for the communication link with the receiver. If, for example, the transmitter determines based on a feed back signal that a communication link with the receiver is sufficiently robust, and thus, requires fewer resources than presently allocated, the transmitter may release some of its allocated resources back to the system. Similarly, if the feed back signal indicates that the communication link has an exceedingly high error rate, the transmitter may request additional band width in order to improve its communication link with the receiver.

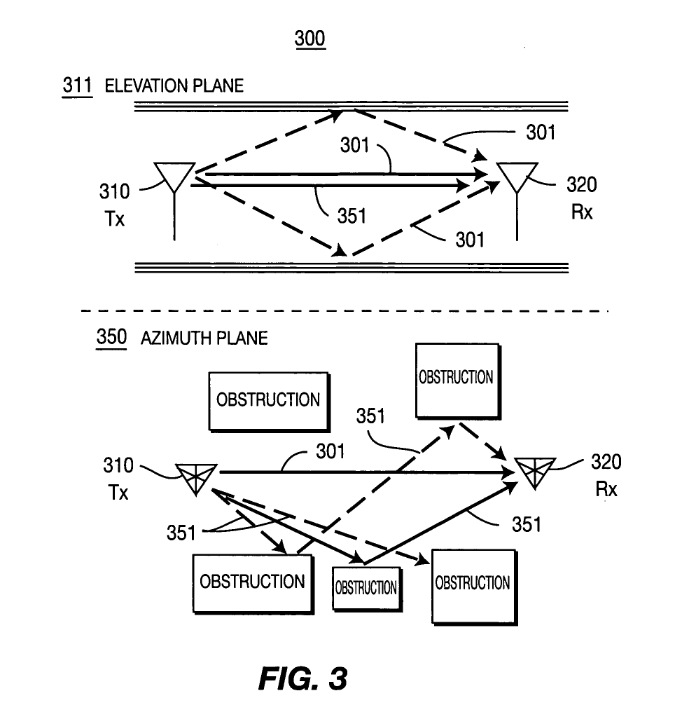

Referring now to FIG. 3, two beams 301, 351 are shown pseudo-randomly dithered in accordance with the present embodiment. For illustrative purposes, the transmission path of one of the beams 301 is shown dithered in the elevation plane 311, while the path of the other beam 351 is shown dithered in the azimuth plane 350. The solid lines in FIG. 3 represent nominal boresight orientations and the dashed lines are dithered orientations. Other beam parameters, such as beam width and beam power, have also been dithered in accordance with the present embodiment. Upon receiving and processing the dithered beams 301, 351, the receiver 320 generates and transmits a feed back signal (not shown) to the transmitter 310. In response to the feed back signal, the transmitter 310 adjusts its dithering patterns.

Gains provided to the system 300 by pseudo-randomly dithering the transmission beams 301, 351 are best described by way of the following illustrative example. It is well known that moving vehicles often experience more robust reception when traveling at high speeds than when traveling at low speeds. This phenomenon is caused by vehicles' ability to quickly enter and exit standing null areas occurring at random locations along their travel paths. When a vehicle travels through a null area slowly, for instance, it remains in that null area longer and thus, may experience long term signal drops. By hastening the speed with which the vehicle travels through the null area, the time spent in the null area, and hence the duration of any signal loss is shortened. Since the vehicle re-enters adequate positions for reception on a regular basis, it will tend to experience more robust reception than slower moving or stationary vehicles.

Pseudo-randomly dithering beam parameters, as described in the present embodiment, is analogous to a vehicle rapidly traveling through null areas. The continual adjustment of beam parameters limits periods of signal interruptions and periods of low data rates. As a result, the communication link between the transmitter 310 and the receiver 320 is more robust and the overall system 300 performance is improved.

In an alternate embodiment, prior to or along with transmitting dithered transmission beams, a transmitter transmits an information signal to a receiver. The information signal informs the receiver of upcoming path and/or parameter changes and the time(s) at which the changes will occur. In response, the receiver makes the appropriate receiving adjustments to properly accommodate the dithered beams. By making these informed adjustments before actually receiving dithered signals, the receiver avoids having to perform an adjustment determining function and thus, the receiver is able to conserve battery power. Where an information signal is not provided by a transmitter, however, the receiver may monitor the radio frequency (RF) paths and/or parameters of received signals in order to generate and make the appropriate receiving adjustments.

Optionally, upon making the appropriate adjustments and receiving the dithered beams, the receiver generates and transmits a feed back signal to the transmitter. As previously described, the feed back signal may include basic QoS measurements, or in more advanced receivers, instructional information. Upon receiving the feed back signal, the transmitter makes appropriate dithering adjustments and signals future beam adjustments to the receiver. The receiver again processes the signaled information, makes the appropriate receiving adjustments, and sends another feed back signal to the transmitter. This transmitter-receiver signaling iteratively improves the communication link between the two and continues until the communication session has ended.

As described in the previous embodiment, the transmitter may utilize the feed back information to request additional system resources or to release (back to the system) a portion of the resources that are presently allocated for its communication link with the receiver. For example, if based on a feed back signal, the transmitter determines that the communication link with the receiver is sufficiently robust, and thus, requires fewer resources than presently allocated, the transmitter may release some of its resources for the establishment of a communication link between two other devices. Similarly, if the feed back signal indicates that the communication link has an exceedingly high error rate, the transmitter may attempt to allocate more band width to improve their communication link.

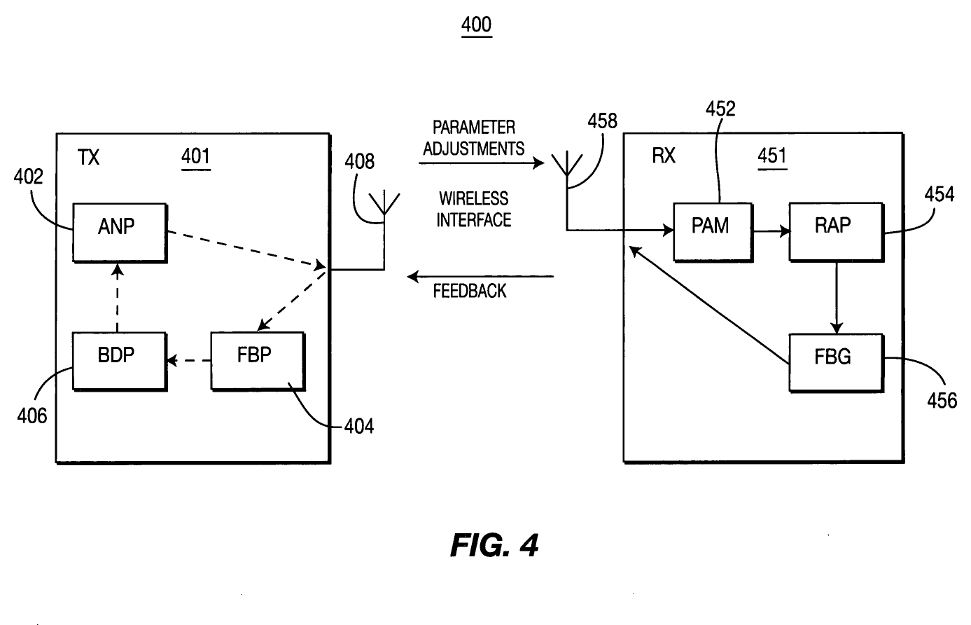

Referring now to FIG. 4, a wireless communication system 400 comprising a transmitter 401 and a receiver 451 configured in accordance with the present invention is shown. The transmitter 401 comprises a parameter adjustment notification processor (ANP) 402, a feed back processor (FBP) 404, a beam dithering processor (BDP) 406, and a transmit/receive antenna 408. The receiver 451 comprises a parameter adjustment monitor (PAM) 452, a receiver adjustment processor (RAP) 454, a feed back signal generator (FBG) 456, and a transmit/receive antenna 458. The transmitter 401 and the receiver 451 are shown communicating via a wireless interface.

Once a communication link is established between the transmitter 401 and the receiver 451, the transmitter's 401 BDP 406 pseudo-randomly adjusts transmit parameters of a transmit data signal (not shown). The parameter adjustment information is sent to the ANP 402 where an information signal is generated. The information signal includes how and when the transmit data signal will be dithered. This information signal is then transmitted via the transmitter's 401 antenna 408 over the wireless interface to the receiver 451.

Upon receiving the transmitted information signal via its antenna 458, the receiver 451 processes the information signal through its PAM 452. The PAM 452 determines which, if any, receiving adjustments must be made in order to accommodate the dithered data signal. It should be noted that if the transmitter 401 is not configured to transmit dithering information signals, or if the information signal is not properly received, the PAM 452 monitors and tracks changing beam parameters and makes its determinations based on the monitored and tracked changes.

The PAM's 452 adjustment determinations are then sent to the RAP 454, where the proper adjustments are made to facilitate receipt of the dithered data signal. Once the receiver 451 has been adjusted and the dithered data signal has been received, the FBG 456 generates a feed back signal. This feed back signal may be a QoS measurement, such as data rate or bit error rate of the received data signal, or the feed back signal may provide dithering instructions to the transmitter 401. The feed back signal is then transmitted over a wireless interface to the transmitter 401 via the receiver's 451 antenna 458.

In the transmitter 401, the feed back signal is received and processed in the FBG 404. If the feed back signal is merely a QoS measurement, the FBG 404 determines appropriate dithering adjustments to improve the measured QoS. Alternatively, if the feed back signal provides dithering instructions, the FBG 404 sends these instructions to the BDP 406, where subsequent data signals are dithered according to the instructions.

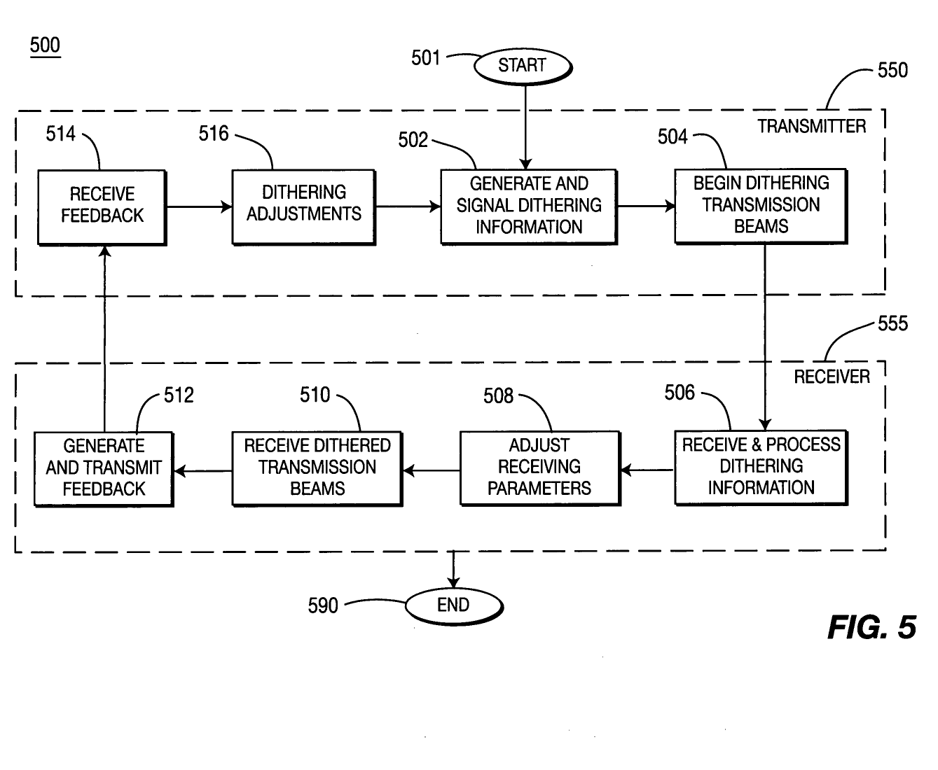

Referring now to FIG. 5, a flow diagram 500 of an embodiment of the present invention is shown. After establishing a communication link (step 501), a transmitter 550 generates and signals dithering information to a receiver 555 (step 502). This dithering information includes how and to what extent particular beam parameters of transmit data signals will be dithered. The transmitter 550 then begins dithering transmission beams (step 504).

Upon receiving the information signal (step 506), the receiver 555 adjusts its receiving parameters (step 508) in anticipation of receiving dithered transmission beams. Once the receiver 555 receives and processes the dithered transmission beams (step 510), the receiver 555 generates and transmits to the transmitter 550 a feed back signal (step 512). This feed back signal may include basic QoS information, or may include instructional information regarding appropriate dithering adjustments to be made by the transmitter 550. When the feed back signal is received at the transmitter 550 (step 514), the transmitter 550 makes the appropriate dithering adjustments (step 516) and generates and signals the adjusted dithering information to the receiver 555 (step 502). This process 500 is repeated and continues until the communication link between the transmitter 550 and receiver 555 ends (step 590).

In any of the previously described embodiments, a transmitter may modify transmission beam parameters via a “sweeping” function in addition to or instead of a pseudo-random dithering function. Sweeping, as described herein, refers to continuous or incremental modification or movement of beam parameters starting at one end of a predetermined range and continuing to the other end of the range. Once the other end of the predetermined range is reached, the modification or movement reverses direction and “sweeps” back to the beginning completing one cycle in a continuous fashion. Sweeping may be more desirable in less sophisticated receivers as the movement of beam parameters is more easily tracked by the receiver.

In addition to pseudo-randomly modifying beam parameters via dithering and/or sweeping functions, or in response to feed back signals, a master controller that controls access points in the communication system and that is aware of channel and/or system conditions may be utilized to provide instructional information regarding how and to what extent particular beam parameters are to be dithered.

For simplicity, the present invention has been described with reference to single input, single output communication systems. It should be understood, however, that the present invention is applicable to MIMO systems. In MIMO systems, each of a plurality of antennas may transmit a different stream of data, or the data from multiple streams may be interleaved and repeated amongst the antennas. The antenna patterns being modified via dithering or sweeping may affect all the streams in the simplest implementation. In a more sophisticated implementation, a subset of the antenna signals may be grouped together in their own beam to be modified individually.

Another variation of the present invention implicates systems utilizing Orthogonal Frequency Division Multiplexing (OFDM). In OFDM implementations, transmission parameters may be modified or adjusted with respect to individual sub-carriers, or with respect to groups of sub-carriers. When used in conjunction with MIMO systems, sub-carriers or groups of sub-carriers may selectively be transmitted from any of a plurality of antennas. Accordingly, any of the above-described embodiments may be implemented in any combination with respect to the sub-carriers and/or transmit antennas, individually or in groups. This added flexibility of parameter control in OFDM MIMO systems further exploits the benefits of the present invention.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for minimizing multipath interference in a wireless communication system, said wireless communication system comprising at least one transmitter and at least one receiver, the method comprising:
at the transmitter, dynamically modifying beam parameters of transmission signals;
transmitting wireless signals using currently selected beam parameters;
at the receiver, monitoring the modified beam parameters;
adjusting receiving parameters to compensate for said modifications and receiving said wireless signals using said adjusted receiving parameters.

2. The method of claim 1 further comprising:
at the transmitter, signaling to the receiver information regarding the parameter modifications including a time and extent of each particular parameter modification; and
at the receiver, adjusting receiving parameters based on said signaled information.

3. The method of claim 2 further comprising signaling to the transmitter feed back information, wherein said feed back information is used by the transmitter to dynamically modify beam parameters.

4. The method of claim 3, wherein the feed back information includes quality of service (QoS) measurements.

5. The method of claim 3, wherein the feed back information provides beam parameter adjustment instructions to the transmitter.

6. The method of claim 3 further comprising:
at the transmitter, utilizing the feed back information to re-allocate radio frequency (RF) resources.

7. The method of claim 3, wherein the beam parameters are modified by pseudo-randomly dithering said beam parameters.

8. The method of claim 3, wherein the beam parameters are modified according to a repetitive sweeping function, whereby at least one beam parameter is incrementally adjusted starting at a first value within a predetermined range of modification until a first end of the modification range is reached; and
upon reaching the first end of the range, reversing direction and incrementally adjusting the at least one beam parameter until a second end of the range is reached.

9. The method of claim 1, wherein the wireless communication system is a multiple input, multiple output (MIMO) communication system wherein the at least one transmitter is configured to transmit data on multiple paths and the at least one receiver is configured to receive data transmitted on said multiple paths.

10. The method of claim 9, wherein the beam parameters are modified with respect to each of a plurality of transmission paths.

11. The method of claim 9, wherein the beam parameters are modified with respect to each of a plurality of transmit antennas.

12. The method of claim 1, wherein the wireless communication system further comprises a master controller unit for monitoring channel conditions in the system and for instructing the transmitter regarding beam parameter adjustments.

13. The method of claim 9 wherein the MIMO wireless communication system further comprises a master controller unit for monitoring channel conditions in the system and for instructing the transmitter regarding beam parameter adjustments.

14. The method of claim 1, wherein the transmitter is a wireless transmit/receive unit (WTRU).

15. The method of claim 1, wherein the receiver is a base station.

16. The method of claim 9, wherein the transmitter is a wireless transmit/receive unit (WTRU).

17. The method of claim 9, wherein the receiver is a base station.

18. The method of claim 9, further comprising modulating user-data to a plurality of sub-carriers utilizing an Orthogonal Frequency Division Multiplexing (OFDM) modulation scheme.

19. The method of claim 18, further comprising adjusting a power level for a combination of sub-carriers and allocating said combination to a group of antennas for transmission.

20. The method of claim 19, wherein the combination of sub-carriers includes a single sub-carrier.

21. The method of claim 19, wherein the group of antennas includes a single antenna.

22. A transmitter comprising:
means capable of dynamically modifying transmission beam parameters according to a pseudo-random dithering function and an iterative sweeping function;
means capable of signaling information to a receiver regarding scheduled parameter modifications;
means capable of processing feed back information; and
means capable of dynamically modifying transmission beam parameters based on said processed feed back information.

23. The transmitter of claim 22, further comprising means capable of allocating RF resources based on said feed back information.

24. The transmitter of claim 22, further comprising means capable of processing beam parameter adjustment instructions from a master controller.

25. The transmitter of claim 22 for use in an OFDM-MIMO communication system, further comprising:
a plurality of antennas;
means capable of transmitting data on multiple paths via the multiple antennas;
means capable of dynamically modifying beam parameters individually for each of the multiple paths; and
means capable of dynamically modifying beam parameters individually for each of the transmit antennas.

26. The transmitter of claim 22 configured to operate in a WTRU.

27. The transmitter of claim 22 configured to operate in a base station.

28. The transmitter of claim 25 configured to operate in a WTRU.

29. The transmitter of claim 25 configured to operate in a base station.

30. The transmitter of claim 25 further comprising means capable of adjusting a power level for a combination of sub-carriers and further comprising means capable of allocating said combination to a group of antennas for transmission, wherein said combination includes at least one sub-carrier and wherein said group includes at least one antenna.

31. A receiver comprising:
means capable of monitoring transmitted beam parameter modifications;
means capable of adjusting receiving parameters to compensate for said modifications;
means capable of receiving and processing signals containing scheduled parameter modifications;
means capable of adjusting receiving parameters to compensate for the scheduled parameter modifications; and
means capable of generating a feed back signal regarding the monitored parameter modifications.

32. The receiver of claim 31, further comprising taking QoS measurements on received signals and signaling the QoS measurements to a transmitter as part of a feed back signal.

33. The receiver of claim 31, further comprising means capable of generating instructional information regarding preferred beam parameter modifications, and means capable of signaling the instructional information to a transmitter as part of a feed back signal.

34. The receiver of claim 31 for use in an OFDM-MIMO communication system, further comprising:
a plurality of antennas; and
means capable of receiving data on multiple paths.

35. The receiver of claim 31 configured to operate in a WTRU.

36. The receiver of claim 31 configured to operate in a base station.

37. The receiver of claim 34 configured to operate in a WTRU.

38. The receiver of claim 34 configured to operate in a base station.
